(19) United States
(12) Patent Application Publication
(10) Pub. No.: US 2016/0212990 A1
(43) Pub. Date: Jul. 28, 2016

(54) MOLD REMOVAL APPARATUS AND METHOD

(71) Applicant: Michael David Maul, Waxhaw, NC (US)

(72) Inventor: Michael David Maul, Waxhaw, NC (US)

(73) Assignee: Innovation Maul, LLC, Waxhaw, NC (US)

(21) Appl. No.: 14/997,563

(22) Filed: Jan. 17, 2016

Related U.S. Application Data
(60) Provisional application No. 62/107,382, filed on Jan. 24, 2015.

(51) Int. Cl. A01N 25/34; A01N 59/14; A01N 25/24; A01N 59/00

(52) U.S. Cl. CPC A01N 25/34; A01N 59/00; A01N 59/14; A01N 25/24

(57) ABSTRACT

A mold elimination apparatus for the purpose of removing molds and mildews is provided. The apparatus comprises an adhesive layer, a permeable film, and one or more absorbent pads carried on and joined by an impermeable or semi-permeable film. The absorbent pad or pads may be provided with a chemical composition suitable for the destruction and removal of molds and mildews, such as bleach. An associated method for the removal of molds and mildews is also provided.

### BACKGROUND OF THE DISCLOSURE

1. Technical Field

The present disclosure relates generally to systems and methods for the removal of molds and mildews and, more specifically, to a mold removal apparatus for the removal of molds and mildews requiring extended treatment.

2. Description of the Related Art

The removal of mold in household and industrial settings can require significant effort from consumers due to the resiliency and environment with which molds and mildews present. Although numerous chemicals such as bleach, detergents, or antifungal agents are available to neutralize and/or remove molds, the application of these chemicals presents a variety of significant hazards and challenges. Caulk and other sealants which are often used in moist environments provide an ideal environment for the growth of mold, requiring repeated chemical treatments in order for the chemicals to penetrate the sealant and fully eliminate microbial growth. Not only is this inconvenient and difficult, but it may repeatedly expose consumers to hazardous or noxious fumes and aerosols. The various chemical sprays, wipes, and liquids available on the market fail to solve this problem, as most are susceptible to rapid evaporation and thus require even more repeated treatments. As a result, consumers may be forced to leave unsightly and potentially dangerous mold in place.

It is clear that a need exists for an apparatus and method whereby a mold-neutralizing chemical may be maintained against a contaminated surface with minimal evaporation of that chemical, thus enabling safe, rapid, and convenient elimination of mold.

### SUMMARY OF THE INVENTION

The present disclosure provides an apparatus which may be used to conveniently remove molds and mildews from surfaces. A method is also disclosed for the neutralization and removal of molds and mildews using the disclosed apparatus.

In one embodiment, the apparatus comprises multiple layers forming an oblong segment for application to a linearly extending region such as a seam or corner area with a substantially L-shaped cross-section. The layers may include an impermeable or semi-permeable first membrane, a permeable second membrane, an absorbent sump carried between and within the first and second membranes, and adhesive areas carried on the longitudinal-edge areas of the permeable second membrane so as to surround the absorbent sump. In this embodiment, the impermeable or semi-permeable first membrane forms the exposed external face of the apparatus while the adhesive functions to secure the apparatus to the affected surface with the permeable second membrane in contact with the affected surface. The membranes may be flexible so as to allow application to surfaces of varying cross-sectional concavity or convexity.

In another embodiment, the apparatus comprises multiple layers in the form of a central triangular region joining three straight segments extending therefrom, forming a substantially Y-shaped body for application to the intersection of multiple corner areas, such as the junction of two walls and a floor. The layers, which maintain the same shape as the body, may include an impermeable or semi-permeable first membrane, a permeable second membrane, an absorbent sump carried between and within the first and second membranes, and adhesive areas carried on the longitudinal-edge areas of the permeable second membrane of each of the three straight segments so as to surround the absorbent sump. As in other embodiments, the impermeable or semi-permeable first membrane forms the exposed external face of the apparatus while the adhesive functions to secure the apparatus to the affected surface with the permeable second membrane in contact with the affected surface. The membranes may be flexible so as to allow application to surfaces of varying shape.

In yet another embodiment, the apparatus comprises multiple layers in the form of an oblong rectangle for application to planar or irregularly-shaped areas. The layers may include an impermeable or semi-permeable first membrane, a permeable second membrane, an absorbent sump carried between and within the first and second membranes, and adhesive areas carried on the permeable second membrane. The adhesive areas may be placed so as to surround the absorbent sump or they may be placed in multiple discontinuous areas, such that the adhesive functions to secure the apparatus to the affected surface with the permeable second membrane in contact with the affected surface. As in other embodiments, the impermeable or semi-permeable membrane forms the exposed external face of the apparatus. The membranes may be flexible so as to allow application to surfaces of irregular shape.

In any and all of the above embodiments, the absorbent sump may be supplied with a mold removal composition. The mold removal composition may comprise a chemical in liquid form. Alternatively, the mold removal composition may comprise a dry chemical which may be activated by exposure to moisture.

In any of the above embodiments, the adhesive may be of a type which is soluble or partially soluble in water, so as to have reduced adhesive capacity after extended exposure to moisture and thus be more easily removed by the user.

It is an object of this disclosure to provide a mold removal apparatus which can be applied to various areas affected by mold.

It is a further object of this disclosure to provide the mold removal apparatus with an adhesive layer whereby the mold removal apparatus may remain securely fixed to various areas affected by mold for an extended period of time.

It is a further object of this disclosure to provide the mold removal apparatus with an absorbent sump carrying a mold removal composition suitable for the elimination of mold.

It is a further object of this disclosure to provide the mold apparatus with a permeable layer so as to allow the mold removal composition to be maintained in contact with the affected surface, thereby eliminating the mold over the duration of contact.

It is a further object of this disclosure to provide a method for the elimination of mold by application of the mold removal apparatus to the affected area by a user.

The features and advantages of the present disclosure will be better described through the detailed description and in reference to the drawing figures which follow.

BRIEF DESCRIPTION OF THE DRAWING FIGURES

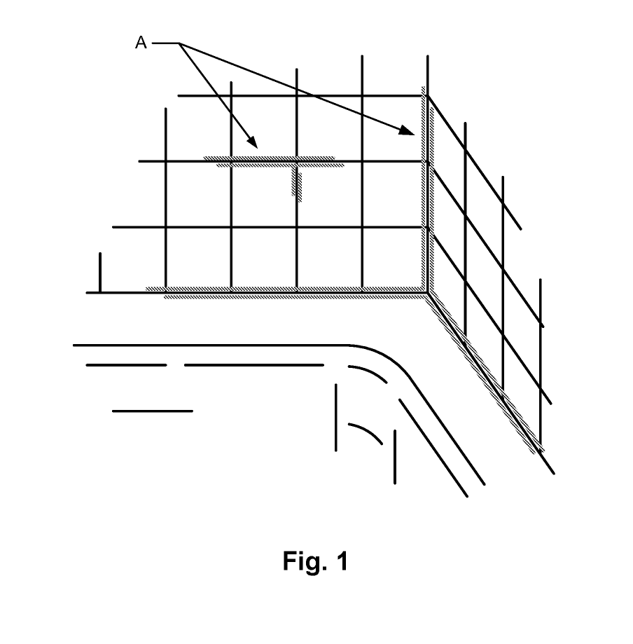

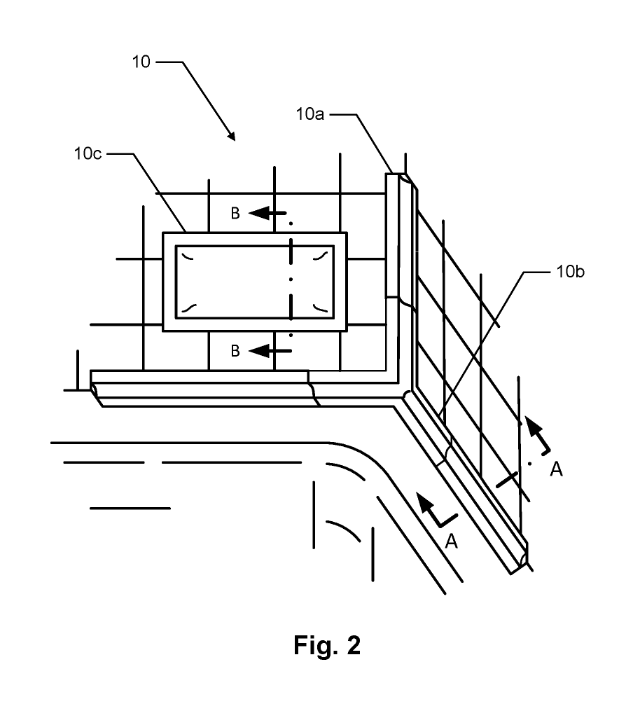

FIG. 1 is a general perspective view of a bathing stall having an accumulation of mold, mildew, or other unwanted microbial growth, concentrated particularly around cracks, crevices, and joints of varying geometry;

FIG. 2 is a detailed perspective view of a bathing stall having application apparatus installed in multiple orientations and/or embodiments;

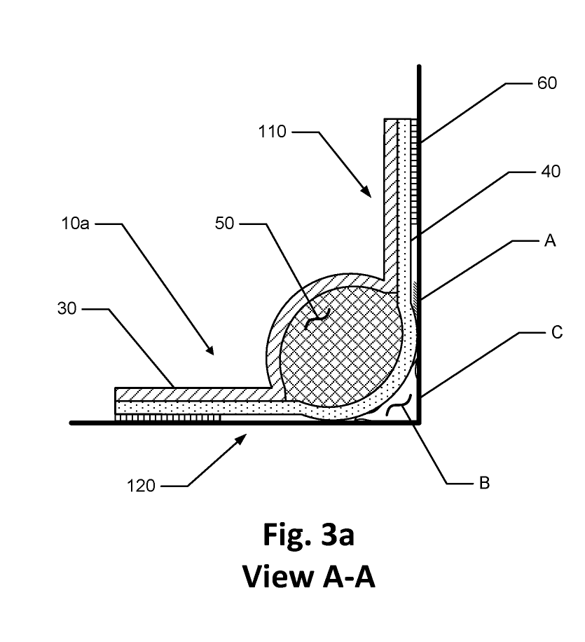

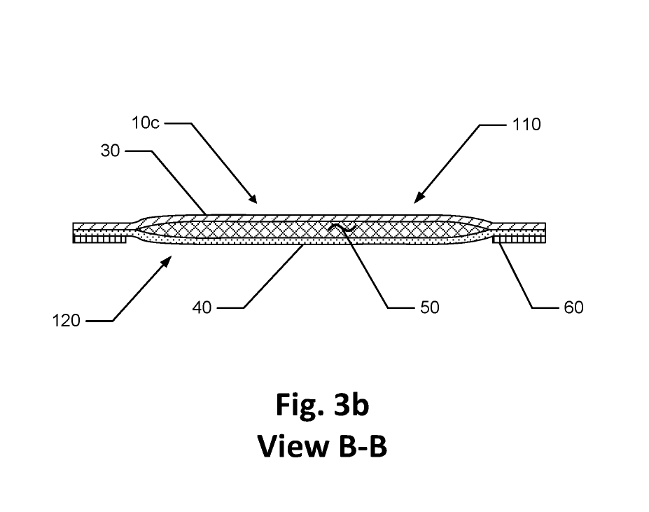

FIGS. 3a and 3b are cross-sectional views of the application apparatus taken from FIG. 2;

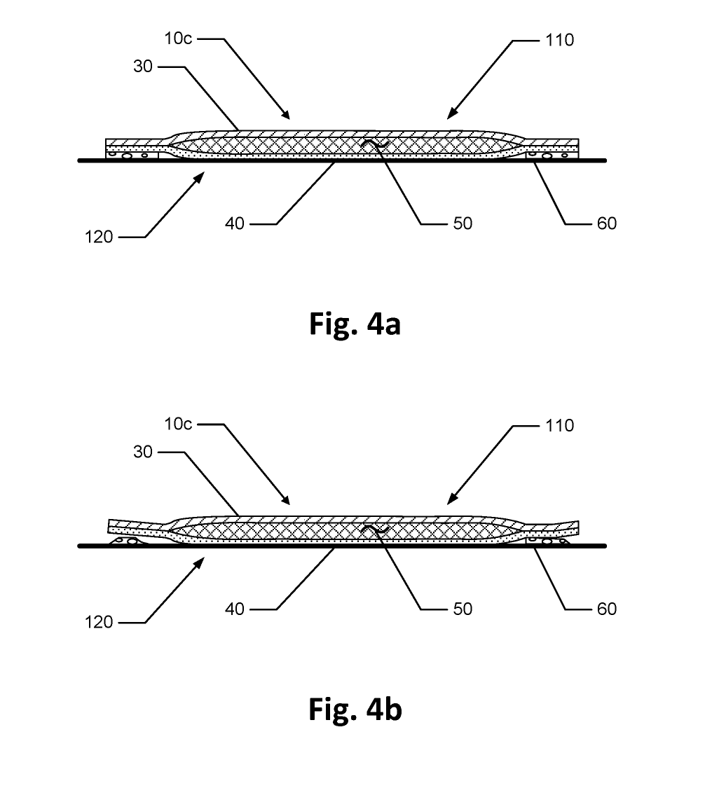

FIGS. 4a and 4b show cross-sectional views over two time periods having adhesive in two states of dissolution.

### DETAILED DESCRIPTION

It should be appreciated that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to removal of mold spores and/or fungi set forth in the following description. The present disclosure is capable of other embodiments and of being used in various applications in which long-term application of a composition subject to evaporation is required. Also, it is to be understood that the phraseology and terminology used herein is for the purpose of description and should not be regarded as limiting. The use of “including,” “comprising,” or “having” and variations herein is meant to encompass the items listed thereafter and equivalents thereof as well as additional items. Further, the terms “a” and “an” herein do not denote a limitation of quantity, but rather denote the presence of at least one of the referenced items.

It should further be appreciated that the terms “mold” and/or “mildew” are used generally and in a non-limiting way in reference to any of numerous molds, spores, mildews, fungal slime, and other undesirable microorganisms which may grow via airborne or water-borne vectors on exposed surfaces in residential, commercial, and/or industrial environments.

Molds, mildews, and other undesirable fungal growth (generally designated in the drawing figures by reference A) may grow on a variety of surfaces in a bathing stall environment, including particularly seams, corners, and planar areas as shown by way of example in FIG. 1. In these areas, the caulk or other material ordinarily used as a sealant (generally designated by reference B) provides an ideal environment for the growth of mold, leading to mold accumulating in numerous areas which are not readily treatable.

In accordance with the present disclosure, FIG. 2 illustrates the mold removal apparatus, generally designated using reference numeral 10, in several embodiments. A first embodiment 10a is depicting comprising an oblong segment having a substantially L-shaped cross-section, installed so as to maintain contact with the edge area at the junction of two walls. A second embodiment 10b is depicted comprising three oblong segments, each having a substantially L-shaped cross-section, joined triangularly at the center to form a substantially Y-shaped body, installed so as to maintain contact with the three-dimensional edge area at the junction of two walls and a floor. A third embodiment 10c is depicted comprising a rectangularly-shaped pad, placed so as to maintain contact with a planar surface.

FIG. 3a is a detailed cross-sectional view showing a first embodiment 10a of the mold removal apparatus 10 installed at the junction of two exemplary perpendicular surfaces C. By way of example, the junction of the two perpendicular surfaces C are depicted as having been sealed with a coating B, such as caulk or other sealant material, where mold A has grown on the surface of the coating B. An impermeable or semi-permeable first layer 30 forms the outer exposed surface 110 of the apparatus 10 while the application side 120, comprising a second layer of a permeable film 40 and an adhesive layer 60, is maintained in contact with the mold A shown on the coating B. The adhesive layer 60 secures the apparatus 10 against the surfaces C. An absorbent sump 50 is carried between and within the first and second layers 30, 40. The permeable film 40 is provided so as to serve as a transmission medium between the absorbent sump 50 and the coating B, thereby allowing prolonged treatment of mold A by the mold removal composition 20 (not shown) carried within the absorbent sump 50.

FIG. 3b is a detailed cross-sectional view showing a third embodiment 10c of the mold removal apparatus 10. An impermeable or semi-permeable first layer 30 forms the exposed outer surface 110 of the apparatus 10 while the application side 120 comprises the permeable film 40 and an adhesive layer 60. An absorbent sump 50 is carried between and within the first and second layers 30, 40 and is permeated with a mold removal composition 20 (not shown).

Although FIG. 2 and FIG. 3b show an adhesive layer 60 implemented so as to surround the circumference of the absorbent sump 50 carried within and between the first and second layers 30, 40 in the third embodiment 10c of the apparatus 10, it should be appreciated that this depiction is presented for exemplary purposes only and that the adhesive layer 60 may be provided in other, non-circumferential configurations so as to more securely adhere the third embodiment 10c of the apparatus 10 to the surface C. For example, the adhesive layer 60 may be provided in the form of multiple parallel segments passing underneath the absorbent sump 50, or in any other suitable configuration as will be readily apparent to those skilled in the art. Similarly, although FIG. 2 and FIG. 3b depict the third embodiment 10c of the apparatus 10 in the form of a substantially oblong rectangle, it should be appreciated that this is only an exemplary depiction and that the third embodiment 10c may be provided in a substantially square, rounded, or other planar geometry as desired for more efficient or effective installation. Moreover, although FIG. 2 depicts the third embodiment 10c of the apparatus 10 installed in a single plane, it should be appreciated and will be readily apparent to those skilled in the art that the third embodiment 10c may be installed or utilized in a multi-planar geometry, such as a curved or rounded fixture, as desired by the user. It should also be appreciated that although FIG. 3a depicts mold A growing on a coating B, this is only provided by way of example and mold A may grow on substantially any surface C with or without a coating B.

The semi-permeable or impermeable first layer 30 may comprise a film of substantially the same material as the permeable film 40 or of a separate material, where the material has a low moisture vapor transmission rate. The first layer 30 may be manufactured by means of a lamination process as known in the art, in which one sub-layer (not shown) of the lamination process includes a low-barrier resilient material such as polyurethane, polyethylene terephthalate, mylar, nylon, polyvinylidene chloride, microcellular urethane, acrylic polymer cement, or any other material having similar properties. Alternately, the sub-layer of first layer 30 may include a thin film deposition process to reduce the moisture vapor transmission rate as is known in the art. For example, vacuum based physical vapor deposition (PVD) processes such as chemical vapor deposition (CVD) may be used for adding aluminum, nickel, or other metallic layer. A further example includes the use of atmospheric based PVD processes such as combustion chemical vapor deposition (CCVD) for adding silicon dioxide (SiO2) or other oxide-based layers that are capable of reducing moisture vapor transmission rates.

The permeable film 40 may comprise a molded, woven, or open-cell material having pores or channels sufficient to allow transmission of the mold removal composition 20 carried within the absorbent sump 50, or any other material having such properties. The effective range of porosities can range from 10 microns to 1000 microns depending on a balance of variables including the effective release rate of the absorbent sump 50, the surface energy of the permeable film 40, the surface tension of the mold removal composition 20, and the application environment.

The mold removal composition 20 may comprise a liquid solution of any chemical suitable for the neutralization of mold, such as sodium hyperchlorite, hydrogen peroxide, sodium borate, ammonia, or any other chemical or chemical agent having suitable antifungal properties.

In an alternative to any of the above embodiments, the absorbent sump 50 may be provided with a dry composition 70 in place of the mold removal composition 20, wherein exposure to moisture activates the dry composition.

The adhesive 60 disclosed may take the form of an acrylic adhesive for secure attachment to ceramic, plastic, or other surfaces, which may or may not be water soluble in order to allow progressive detachment and removal of the mold removal apparatus. A slowly-water soluble adhesive may take the form of polyvinylpyrrolidone, cellulose ethers, methylcellulose, carboxymethylcellulose, or other synthetic or nonsynthetic dissolvable adhesives. In such a case, the adhesive 60 may comprise a mixture of water soluble and non-water soluble adhesive compounds in order to control the rate at which the adhesive breaks down, ensuring sufficient treatment time. The activation of the adhesive 60 may be due to pressure-sensitive properties or to the use of moisture as an initial primer.

In an alternative embodiment, the adhesive 60 may optionally be separate, wherein the adhesive 60 is independent of the mold removal apparatus 10.

### EXAMPLE

By way of example, a user having unwanted mold growth A on various coatings B and surfaces C in a bathing stall environment may install various embodiments of the mold removal apparatus 10 as needed to ensure complete coverage of the mold A by the apparatus 10. A user having mold A at the junction of two walls or a wall and floor, forming an L-shaped surface, may utilize the first embodiment 10a, such that the adhesive layer 60 secures the apparatus 10a to the opposing perpendicular surfaces C with the permeable film 40 maintained against the mold A. Alternatively, a user may utilize the second embodiment 10b or third embodiment 10c as desired to match the geometry of the affected surface C. In any such situation, the semi-permeable or impermeable first layer 40 serves to protect the absorbent sump 50 as the mold removal composition 20 is transmitted through the permeable film 40 to the mold A. In an alternative embodiment where the absorbent sump 50 is provided with a dry composition 70 and the first layer 30 is semi-permeable, the ordinary use of the bathing stall environment may expose the apparatus 10 to moisture, allowing the first layer 30 to transmit water into the absorbent sump 50, thus activating the dry composition 70 and initiating transmission of the activated dry composition 70 through the permeable film 40 for treatment of mold A.

The example application and use of the mold removal apparatus provided above implicitly discloses an associated method for the elimination of molds and mildews requiring extended chemical exposure, which is explicitly disclosed as the removal of dirt or surface contaminants from the affected surface; the priming of the mold removal apparatus, whether by extraction from a protective covering, by moistening with water, or by any other suitable priming step; the placement of the mold removal apparatus against the affected surface such that the adhesive securely maintains the permeable membrane in contact with the affected surface; the elapse of some duration of time such that the mold-eliminating chemical may fully permeate the affected surface, and the removal of the mold removal apparatus once the mold has been eliminated.

The method may also include the step of repeatedly moistening the mold removal apparatus in order to reactivate the mold-eliminating chemical. In some environments or applications, this may require deliberate action on the part of the user, while in other applications this step may comprise the ordinary use of the environment.

It should be appreciated, and will be clear to those skilled in the art that modifications and/or changes may be made to the embodiments of the disclosure without departing from the mold removal apparatus as disclosed herein. For example, while the embodiments herein depict an adhesive layer which is distinct from the permeable membrane, the mold removal apparatus may be provided with an adhesive material which is itself permeable to the mold-elimination solution carried within the absorbent sump, thus combining the function of the adhesive layer with that of the permeable membrane. Accordingly, the foregoing description and the accompanying drawings are intended to be illustrative of the example embodiments only and not limiting thereto.

What is claimed:

1) A mold removal apparatus for extended treatment of mold by a mold removal composition, comprising:
a) a layer of semi-permeable or impermeable film, wherein at least a portion of the semi-permeable or impermeable film includes an exposed side;
b) an absorbent sump for holding and releasing a mold release composition; and
c) a layer of permeable film covering at least a portion of the sump, wherein at least a portion of the permeable film includes an application side.

2) The mold removal apparatus of claim 1, wherein the absorbent sump comprises a layer or body of compressible open cell foam.

3) The mold removal apparatus of claim 1, wherein the absorbent sump is provided with a mold removal composition.

4) The mold removal apparatus of claim 3, wherein the mold removal composition comprises sodium hyperchlorite, hydrogen peroxide, sodium borate, ammonia, or any other chemical or chemical agent having suitable antifungal properties.

5) The mold removal apparatus of claim 3, wherein the mold removal composition is provided in a liquid solution.

6) The mold removal apparatus of claim 3, wherein the mold removal composition is provided as a dry composition which may be activated by exposure to moisture.

7) The mold removal apparatus of claim 1, wherein the semi-permeable or impermeable film is provided with at least one layer selected from a group consisting of polyurethane, polyethylene terephthalate, mylar, nylon, polyvinylidene chloride, microcellular urethane, acrylic polymer cement, a metallic layer, and an oxide layer.

8) The mold removal apparatus of claim 1, wherein the permeable film comprises a layer formed of polyester, polyamide, polytetrafluoroethylene, a woven material, or any other material with a high moisture vapor transmission rate.

9) The mold removal apparatus of claim 1, wherein the permeable film is comprised of a material having a moisture vapor transmission rate sufficient to allow moisture to enter the absorbent sump.

10) The mold removal apparatus of claim 1, wherein an adhesive layer is disposed on at least a portion of the application side of the apparatus.

11) The mold removal apparatus of claim 10, wherein the adhesive layer is provided with an adhesive material selected from a group consisting of acrylic, polyvinylpyrrolidone, cellulose ethers, methylcellulose, and carboxymethylcellulose.

12) The mold removal apparatus of claim 10, wherein the adhesive layer is a least partially water soluble.

13) The mold removal apparatus of claim 10, wherein the mold removal apparatus is provided with an adhesive layer disposed on at least a portion of the application side of the apparatus.

14) The mold removal apparatus of claim 10, wherein the adhesive layer is provided with an adhesive material selected from a group consisting of acrylic, polyvinylpyrrolidone, cellulose ethers, methylcellulose and carboxymethylcellulose.

15) A method of mold removal from a mold-affected surface, generally comprising the steps of:
a) providing a mold removal apparatus including a semi-permeable or impermeable first layer, a permeable film, and an absorbent sump;
b) providing the absorbent sump within and between the first and second layers;
c) providing the absorbent sump with a mold removal composition;
d) priming the mold removal apparatus for application to a surface;
e) installing the mold removal apparatus such that it is secured to a mold-affected surface, where the mold removal composition is in contact with a mold-affected surface;
f) providing a time delay for treatment; and
g) removing the mold removal apparatus from the mold-affected surface.

16) The method of claim 17, wherein the mold removal apparatus is provided with an adhesive layer disposed on at least a portion of the application side of the apparatus.

17) The method of claim 18, wherein the adhesive layer is used to secure the mold removal apparatus to a mold-affected surface for the duration of the time delay.

18) The method of claim 19, wherein the adhesive layer comprises a material which is at least partially water soluble.

19) The method of claim 20, wherein the adhesive layer comprises a material which is provided with suitable water solubility so as to dissolve at some time after the time delay has elapsed.
